(19) United States
(12) Patent Application Publication
(10) Pub. No.: US 2018/0194119 A1
(43) Pub. Date: Jul. 12, 2018

(54) MULTI-LAYERED FILM AND BUILDING FACADE ELEMENT HAVING A COATING MADE OF A MULTI-LAYERED FILM

(71) Applicant: KONRAD HORNSCHUCH AG, D-74679 WEISSBACH (DE)

(72) Inventors: Sabine MAYER, Öhringen (DE); Astrid ALBRECHT, Besigheim (DE); Marion KNIERIM, Kupferzell (DE)

(21) Appl. No.: 15/742,301

(22) PCT Filed: Jul. 4, 2016
(86) PCT No.: PCT/EP2016/065674

§ 371 Date: Jan. 5, 2018

(30) Foreign Application Priority Data
Jul. 6, 2015 (AT) 501402015

(51) Int. Cl. B32B 27/18; B32B 3/26; B32B 7/12; B32B 27/08; B32B 27/22; B32B 27/30; E04F 13/077; E06B 1/34

(52) U.S. Cl. CPC B32B 27/18; B32B 2607/00; B32B 7/12; B32B 27/08; B32B 27/22; B32B 27/304; B32B 27/308; E04F 13/077; E06B 1/34; B32B 2250/24; B32B 2255/10; B32B 2307/71; B32B 2307/712; B32B 2307/75; B32B 2419/00; B32B 3/263

(57) ABSTRACT

A multi-layered film including a polyvinyl chloride (PVC)-based base layer containing a plasticizer and including a surface layer containing a UV stabilizer that is adhesively bonded to the base layer, wherein an acrylate-based PVC-free copolymer is used as a plasticizer in the base layer.

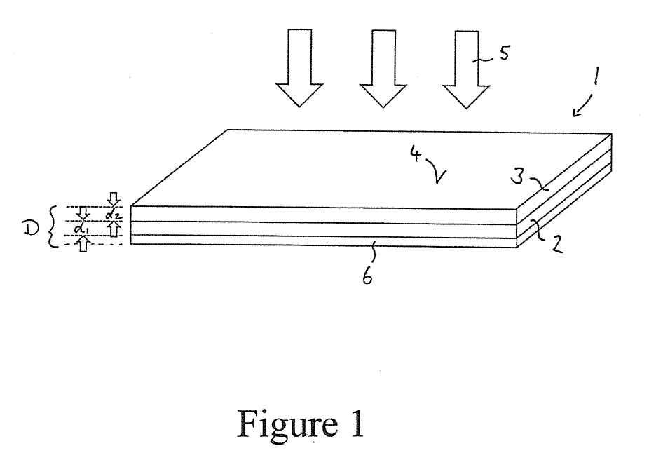

### BACKGROUND OF THE INVENTION

### Field of the Invention

This invention relates to a multi-layered film, which has a surface layer with a UV protection and has a polyvinyl chloride (PVC)-based base layer, and also relates to a building façade element, in particular a window profile, having a coating including the film.

### Discussion of Related Art

Films of this kind are known, for example, in the form of films for coating surfaces that are exposed to solar radiation and other climatic influences such as window profiles, garage doors, door panels, façade components and the like. They should have a long service life and despite exposure to sunlight, primarily the UV portion with a wavelength in the 300-400 nm range, temperature, and other climatic influences, should remain firmly attached to the base without any noticeable discoloration or alteration. In order to obtain flexible PVC films for application, usually external plasticizers are used. A migration of the plasticizer, however, can result in a crack formation in the acrylic covering film and may possibly reduce its T_{g}, which results in a change in the behavior with regard to migration processes and reduces the service life of the product.

There is also a possibility of the plasticizer, encouraged by certain environmental conditions, accumulating at the lowerboundary surface of the PVC film through migration and thus potentially exerting a negative influence on adhesive bonds.

### SUMMARY OF THE INVENTION

One object of this invention is to provide a film of the type mentioned above in which the problem of the migration of the plasticizer and its effects is solved.

This object and other objects are attained by embodiments and details discussed in this specification and in the claims.

According to one aspect of this invention, a multi-layered film is disclosed, which includes a polyvinyl chloride (PVC)-based base layer containing a plasticizer and includes a surface layer containing a UV stabilizer that is adhesively bonded to the base layer. A plasticizing and flexibility-promoting component in the form of an acrylate-based PVC-free copolymer is used in the base layer.

In addition to the base layer and the surface layer, the film can also have other layers. Typically, but not necessarily, the surface layer is transparent.

The use of a PVC-free acrylic copolymer as a plasticizing recipe component, such as the commercially available Kane Ace CSR3, has one advantage that it hinders a migration of the plasticizer. As experiments have demonstrated, in the multi-layered film according to this invention, even after an exposure time of more than 26,000 hours and dosage of more than 50,000 MJ/m², no damage to or destruction of the surface layer and no decomposition of PVC occur. By contrast, with known films, after 17,000 hours and an exposure dosage of 33,320 MJ/m², a decomposition of PVC and destruction of the surface layer occurred.

Accordingly, the external plasticizer that has been customary up to now has been replaced with acrylate-based flexible, polymer plasticizers, which achieves a reduction of the migration of the plasticizer and thus a significantly extended service life of the multi-layered film, particularly in exterior use.

According to one embodiment of this invention, the base layer has a component a of PVC, where 30%≤a≤80%. A component b of the acrylate-based PVC-free copolymer in the base layer can amount to 20%≤b≤50%.

The base layer can also contain a component c of a thermal stabilizer, where 1%≤c≤5%.

In one embodiment of this invention, the surface layer is embodied as an acrylate-based UV-protection film. Its thickness can, for example, lie between 30 micrometers and 100 micrometers.

The surface layer can alternatively also be embodied in the form of PMMA/PVDF film (polymethyl methacrylate film and/or polyvinylidine fluoride film).

Another alternative is the use of an acrylate-based finish with UV-absorbers as a surface layer.

There are various possibilities for achieving the UV protection by the UV stabilizers. According to one embodiment of this invention, the surface layer contains UV absorbers with a component d, where 0.2%≤d≤3%.

Alternatively or in addition, the surface layer can contain UV stabilizers in the form of sterically hindered amines (hindered amine light stabilizers, HALS) in a component e, where 0.2%≤e≤3%. In this case, various HALS types can be combined.

According to one embodiment, the base layer and/or the surface layer each contains phenolic and/or phosphite-containing co-stabilizers. For example, organic phosphite in a percentage between 0.2% and 1% can be used as a co-stabilizer.

In one embodiment of this invention, the base layer and the surface layer are thermally laminated and form a composite. The multi-layered film can thus be processed as a whole and can, for example, be used for coating surfaces.

According to one embodiment of this invention, the base layer is printed and/or dyed with weather-resistant organic or inorganic pigments. Alternatively or in addition, the surface layer can also be embossed. It is thus possible to create decorative films, for example with a wood-like appearance.

The base layer is preferably produced by calendering. The base layer can be printed, for example, with an intaglio printing process. By thermal lamination, the base layer can be bonded to a PMMA-based surface layer and then a structure/grain can be introduced into it.

A transparent, acrylate-based covering film with various UV-absorbers and HALS types can be produced using the extrusion process.

According to another aspect of this invention, a building façade element is disclosed, which has a coating made of the multi-layered film. The building façade element can be a region of an external façade, a door panel, a garage door, paneling, or facing shells. The building façade element is thus colorfast and low-maintenance.

The processing of the film into a coating is carried out, for example, by profile coating, coil coating, 2D surface lamination (hot and cold gluing), or sheet extrusion with thermal lamination of the film.

The multi-layered film is especially used for coating window profiles. In particular, using the multi-layered film as a coating can give plastic window frames a high-quality appearance while simultaneously providing them with an outstanding service life.

### BRIEF DESCRIPTION OF THE DRAWINGS

Embodiments of this invention will be described in greater detail below in conjunction with a FIGURE. The sole FIGURE schematically shows a multi-layered film according to one embodiment of this invention.

In the embodiment shown, the multi-layered film 1 has a polyvinylchloride (PVC)-based base layer 2, which contains a plasticizer. An acrylate-based PVC-free copolymer is used as a plasticizer. The base layer 2 has a thickness d₁ of 120 micrometers. The thickness d₁ can, for example, be between 70 and 300 micrometers.

On the top surface of the base layer 2, a surface layer 3 is provided and is adhesively bonded to it. It can be embodied in the form of an acrylate film, a PMMA/PVDF film, or in the form of a finish, such as an acrylate-based one. The surface layer 3 can have a thickness d₂ of 50 micrometers. For example, d₂ can be between 30 and 100 micrometers. When the surface layer 3 is embodied as a finish layer, the thickness d₂ is 3 to 10 micrometers.

The top surface 4 of the surface layer 3 forms the top surface of the film 1. It can thus be exposed to direct solar radiation, which is indicated by the arrows 5. This is why the surface layer 3 can be provided with UV stabilizers, which increase the light resistance of the film 1.

In the embodiment shown, the underside of the base layer 2 can have a coupling agent layer 6. The coupling agent layer 6 is used for applying the film 1 to a surface that is to be coated such as a window profile and for producing a permanent bond to it.

The film 1 has a total thickness D, which corresponds to at least the sum of d₁ and d₂ and which in the exemplary embodiment shown is 210 micrometers. Basically, D can for example lie between 100 and 400 micrometers.

The composition of the film 1 is indicated in Table 1. In some cases, the advantageous range is provided in parentheses after the quantity indications relating to the specific example.

TABLE 1

| | Content in % | |
|---|---|---|
| Raw material | | |
| PVC | 52.5 | (30-80) |
| Acrylic copolymer (PVC-free, used as | 35 | (20-50) |
| a plasticizer) | | |
| Thermal stabilizer | 2.6 | |
| Light protection composed of: | 0.9 | |
| Absorbers | 0.45 | (0.2-3) |
| NOR-HALS | 0.45 | (0.2-3) |
| Co-stabilizer: | | |
| Organic phosphite | 0.4 | (0.2-1) |
| Acryl. processing aid | 0.6 | |
| Epoxidized soybean oil | 6.9 | |
| Acrylic lubricant | | |

| | |
|---|---|
| +TiO₂/pigments (also added) | +15 |

1. A multi-layered film (1), comprising:
a polyvinyl chloride (PVC)-based base layer (2) containing a plasticizer,
a surface layer (3) containing a UV stabilizer that is adhesively bonded to the base layer (2), and
an acrylate-based PVC-free copolymer used as a plasticizer in the base layer (2).

2. The multi-layered film (1) according to claim 1, wherein the base layer (2) has a component a of PVC, where 30%≤a≤80%.

3. The multi-layered film (1) according to claim 2, wherein the base layer (2) has a component b of the acrylate-based PVC-free copolymer, where 20%≤b≤50%.

4. The multi-layered film (1) according to claim 3, wherein the base layer (2) has a component c of a thermal stabilizer, where 1%≤c≤5%.

5. The multi-layered film (1) according to claim 4, wherein the surface layer (3) is embodied in a form of an acrylate-based UV-protection film.

6. The multi-layered film (1) according to claim 4, wherein the surface layer (3) is embodied in a form of a PMMA/PVDF film.

7. The multi-layered film (1) according to claim 4, wherein the surface layer (3) is embodied in a form of an acrylate-based finish with UV-absorbers.

8. The multi-layered film (1) according to claim 7, wherein the surface layer (3) contains UV absorbers with a component d, where 0.2%≤d≤3%.

9. The multi-layered film (1) according to claim 8, wherein the surface layer (3) contains light protection in a form of sterically hindered amines or hindered amine light stabilizers (HALS) in a component e, where 0.2%≤e≤3%.

10. The multi-layered film (1) according to claim 9, wherein the base layer (2) and/or the surface layer (3) each contains phenolic and/or phosphite-containing co-stabilizers.

11. The multi-layered film (1) according to claim 10, wherein the base layer (2) and the surface layer (3) are thermally laminated and form a composite.

12. The multi-layered film (1) according to claim 11, wherein the base layer (2) is printed and/or dyed.

13. The multi-layered film (1) according to claim 12, wherein the surface layer (3) is embossed.

14. A building façade element having a coating made of the multi-layered film (1) according to claim 1.

15. A building façade element according to claim 14, which is embodied as a window profile.

16. The multi-layered film (1) according to claim 1, wherein the base layer (2) has a component b of the acrylate-based PVC-free copolymer, where 20%≤b≤50%.

17: The multi-layered film (1) according to claim 1, wherein the base layer (2) has a component c of a thermal stabilizer, where 1%≤c≤5%.

18. The multi-layered film (1) according to claim 1, wherein the surface layer (3) is embodied in a form of an acrylate-based UV-protection film.

19. The multi-layered film (1) according to claim 1, wherein the surface layer (3) is embodied in a form of a PMMA/PVDF film.

20. The multi-layered film (1) according to claim 1, wherein the surface layer (3) is embodied in a form of an acrylate-based finish with UV-absorbers.

21. The multi-layered film (1) according to claim 1, wherein the surface layer (3) contains UV absorbers with a component d, where 0.2%≤d≤3%.

22. The multi-layered film (1) according to claim 1, wherein the surface layer (3) contains light protection in a form of sterically hindered amines or hindered amine light stabilizers (HALS) in a component e, where 0.2%≤e≤3%.

23. The multi-layered film (1) according to claim 1, wherein the base layer (2) and/or the surface layer (3) each contains phenolic and/or phosphite-containing co-stabilizers.

24. The multi-layered film (1) according to claim 1, wherein the base layer (2) and the surface layer (3) are thermally laminated and form a composite.

25. The multi-layered film (1) according to claim 1, wherein the base layer (2) is printed and/or dyed.

26. The multi-layered film (1) according to claim 1, wherein the surface layer (3) is embossed.
